(19) United States
(12) Patent Application Publication
(10) Pub. No.: US 2005/0122291 A1
(43) Pub. Date: Jun. 9, 2005

(54) Optically addressable pixel and receptacle array

(76) Inventor: Gregory J. May, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/729,178

(22) Filed: Dec. 4, 2003

(51) Int. Cl. G09G 3/32

(52) U.S. Cl. 345/83

(57) ABSTRACT

An optically addressable pixel of an exemplary embodiment includes an emission sensor and a filter disposed to filter emissions directed toward the emission sensor. An emission device is responsive to the emission sensor. A frame is configured to hold the emission sensor, the emission device and the filter, and to pass electric current to the emission device when an outer surface of the frame is brought into contact with a powered conductor.

### FIELD OF THE INVENTION

The invention is in the optically addressable display field.

### BACKGROUND OF THE INVENTION

In an optically addressed array, optical signaling is used to activate pixels. When light addresses a particular pixel, for example a light emitting diode, it produces a display. In a typical device, to produce a color display, three colors of light emitting diodes (LEDs) are used. To address the three types of LEDs separately, each is typically equipped with a color filter, and colored light is produced in phases to activate the three types of LEDs. Color filters are generally expensive, and especially so for displays with a larger number of pixels. The use of colored light signals to optically address pixels can also result in interference in that the colored light used to address the pixels can mix in with the optically display produced by the pixels themselves.

Current techniques for arranging and supporting optically addressable pixels are inefficient and costly. Discrete printed circuit board (“PCB”) loading is the most common method of arranging and supporting an optically addressable pixel. Discrete PCB loading inefficiently utilizes the available space available on the PCB. In the case of front projection to address the optically addressed array, components are loaded only on top of the PCB surface while relying upon the PCB as the only backplane. The components of the pixel such as the emissive and receptive portions are loaded on the same surface of the PCB. The cost per pixel is increased and the resulting resolution of the display drops when trying to implement this method into today's production processes. The discrete PCB loading method also limits the minimum pixel area because of the inefficient use of the PCB space. While the rear projection configuration is more space efficient (components on both sides of the PCB), costs are still high and still do not approach the resolution capable of this new methods.

Discrete PCB loading also creates problems for replacing or reconfiguring the pixels. The pixels and their elements are soldered to the PCB with a specific orientation. If the pixel becomes damaged, the entire PCB usually has to be replaced as compared to replacing the damaged pixel. Replacing the entire PCB is expensive and usually cannot be done onsite. The arrangement and orientation of the pixels cannot be changed once they are soldered. If a new color arrangement is desired, the individual pixels cannot be changed. Instead, a PCB with the new arrangement is needed, resulting in increased costs. There remains a need for an improved optically addressed display.

### SUMMARY OF THE INVENTION

An optically addressable pixel of an exemplary embodiment includes an emission sensor and a filter disposed to filter emissions directed toward the emission sensor. An emission device is responsive to the emission sensor. A frame is configured to hold the emission sensor, the emission device and the filter, and to pass electric current to the emission device when an outer surface of the frame is brought into contact with a powered conductor.

### BRIEF DESCRIPTION OF THE DRAWINGS

FIGS. 1A and 1B are block diagrams illustrating exemplary embodiment optically addressable pixels;

FIGS. 2A-2B are schematic views of an exemplary optically addressable pixel for a rear projection display;

FIG. 2C is a schematic view of an exemplary optically addressable pixel for a front projection display;

FIGS. 3A-3D are schematic views of an exemplary embodiment pixel that is rotationally sensitive;

FIG. 4 is a schematic view of another exemplary embodiment pixel that is rotationally sensitive;

FIG. 5 is a schematic view of an exemplary embodiment pixel receptacle array; and

FIG. 6 is an exemplary embodiment rear projection display.

### DETAILED DESCRIPTION OF THE INVENTION

The present invention is directed to optically addressable pixels and a receptacle array. A receptacle array of the invention defines receptacles that receive pixels of the invention. Electrical connection is provided to a pixel when it is placed in a receptacle of the array through electrical contact between the pixel and the receptacle or through pins extending from the pixel. Individual pixels are readily replaced as pixels may be plugged into the receptacle array and removed from the array. No soldering or wiring operation is required, as the receptacle array and/or pins provide electrical connections to pixels upon insertion.

In exemplary embodiments, geometric receptacles accept pixels. Preferred hexagon shaped receptacles may form a honeycomb receptacle array. This provides a sound structure, convenient power delivery through the honeycomb array, and close packing of pixels. Distinct rotational positions for pixels are provided by the geometric receptacles. This permits a multi-color pixel to be consistently placed in each receptacle. In this manner, a particular color management scheme may be followed. In some embodiments, the pixels have three different colored emission devices, and the rotational orientation of adjacent pixels determines how the color response of the neighbor pixels will blend.

A preferred multi-color pixel of the invention has a frame shaped to fit a corresponding receptacle and make electrical contact with the receptacle. A suitable emission device is a light emitting diode (LED). There is an LED for each color. An emission sensor corresponds to each separate LED and responds to emissions of a different band. Other embodiments may use different emission devices, e.g., vertical cavity surface emitting lasers or other emission devices capable of producing emissions. In some embodiments, there may also be emission devices with emissions outside of the visible spectrum. These may be used with in combination with visible emission devices, e.g., LEDs, in a display to provide some additional information to be sensed. In other embodiment, nonvisible emission devices may produce emissions that are then translated into a visible display.

A replacement pixel is also provided by the invention. A replacement pixel is capable of producing a response of one color or any of a plurality of colors. A preferred embodiment replacement pixel capable of producing one of a plurality of colors may be set to select a color. Accordingly, individual single color pixels in a receptacle array of the invention may be replaced with a replacement pixel, which therefore forms a universal replacement pixel. In some applications, such as very large macro displays, the color of a replacement pixel may be relatively unimportant. Embodiments of the invention include replacement pixels of an arbitrary color of a particular color scheme to be placed in any geometric location of a pixel array. The response of such a replacement pixel replaces a “dead” pixel, which draws significant attention, with a responsive pixel that fills in dead space with an arbitrary color of the color scheme. The replacement pixel becomes virtually undetectable in a large display, even if it responds to a different color than the “dead” pixel it replaces.

An exemplary receptacle array is configured as a honeycomb. The honeycomb shape overlaps adjacent rows and columns of pixels to permit a high-resolution display. The interlocked nature of the honeycomb receptacle array also provides a structural integrity, which is especially important for optically addressed arrays used in stadium-sized displays, for example. A honeycomb array may easily be attached to the power supply at the ends of the panels for easy power distribution across the panel. The honeycomb need only provide power and ground. Power distribution can be enhanced by creating pixels that are just capacitors. For example, ends of runs in the array can be loaded around the perimeter with these capacitors. Also, the structure itself can have high frequency capacitance if rows in the array are insulated from each other but in close proximity to adjacent rows.

An exemplary display device of the invention uses a sequence of different polarization phases to encode different color channels. For example, three polarization phases encode three color channels. During one of the phases, data for the corresponding color channel is added to the emissions, for example by an array of digital mirrors. During the subsequent two phases, the other colors are encoded. Polarization filters determine which display elements respond. In exemplary embodiments, a pixel corresponds to the resolution encoded by one of the digital mirrors. The pixel itself may include one emission device, e.g., an LED of one color, or many display elements, e.g., many LEDs of different colors. Another exemplary display device of the invention uses plural polarization phases simultaneously to encode two or more color channels. The polarization filters again determine which display elements in pixels respond, but the color channels are delivered at the same time instead of sequentially.

Alternate embodiments of the invention include preferred pixels having a frame shaped to fit into a corresponding receptacle of a receptacle array and have power provided to the pixel through the receptacle. These pixels may be single color or multi-color pixels. These pixels may make use, for example, of color filters for coding color channels according to color emissions in place of the polarized emissions discussed above.

A preferred pixel of the invention is a tri-color pixel, as current color science and management makes prevailing use of a tri-color scheme. However, the polarization encoding scheme is well-suited to any multi-color scheme, and will apply equally as color science changes, for example as new physical display elements and combinations develop. Artisans will also appreciate that the color encoding scheme enabled by pixels of the invention will adapt to different color management, for example a choice of colors other than the prevailing RGB management choice. Artisans will accordingly appreciate that the exemplary tri-color pixels and exemplary color management schemes in the preferred embodiment serve as an illustration of multi-color pixels in making use of any color science and any color management scheme.

The invention will now be illustrated with respect to exemplary embodiment devices. Methods of the invention will also be apparent from the following discussion. In describing the invention, particular exemplary devices will be used for purposes of illustration. The drawings are not to scale. Illustrated devices may be schematically presented, and exaggerated for purposes of illustration and understanding of the invention.

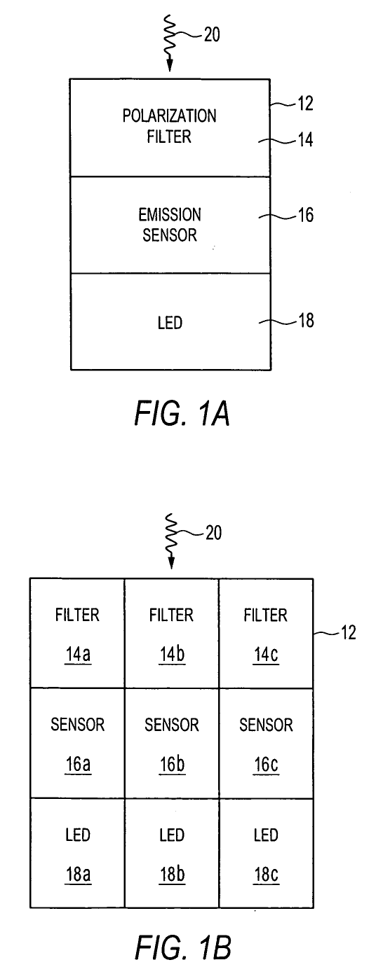

In FIG. 1A, an exemplary optically addressable pixel is represented. A frame 12 houses a polarization filter 14, an emission sensor 16, and an LED 18. The polarization filter 14 filters a polarized emission 20, which is used to provide display data. An emission 20 that is sufficiently different from a corresponding phase of the filter 14 will not induce a response in the emission sensor 16. On the other hand, a polarized emission 20 with the correct phase or within an allowable variation passes through the polarization filter 16, the emission 20 will activate the emission sensor 16. When it is activated, the emission sensor 16 responds by activating the LED 18.

A tri-color pixel is represented in FIG. 1B. The pixel includes three LEDs 18a, 18b and 18c, for example, red, green and blue. The LEDs 18a, 18b and 18c are respectively responsive to sensors 16a, 16b and 16c, which have respective polarization filters 14a, 14b and 14c. Each of the filters 14a, 14b and 14c passes a different band of polarized emissions. Accordingly, bands of emissions form different color channels. In alternate embodiments, the filters 14a, 14b, and 14c comprise color filters. Such a pixel may be used in cases where color bands of emissions encode different color channels. The rotational attitude of the pixel in such embodiments is unimportant, but the pixel still provides advantages by its structure and the manner by which it may be inserted into a corresponding receptacle array.

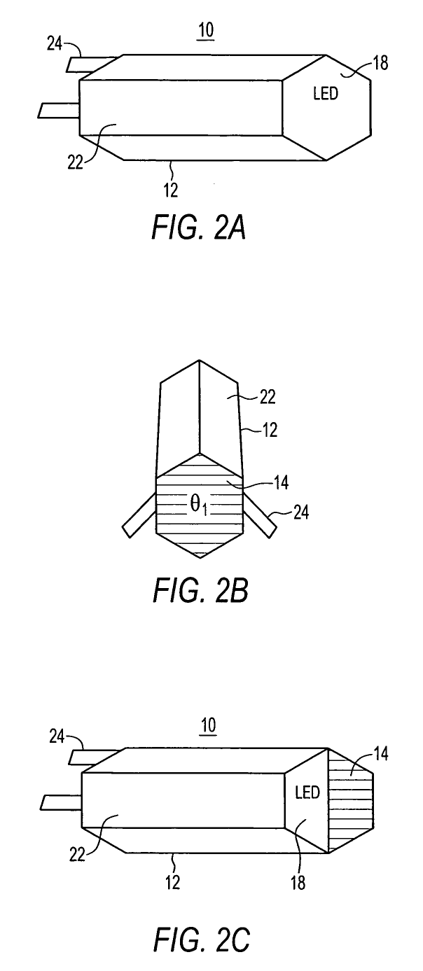

FIGS. 2A-2B schematically illustrate the mechanical structure of a preferred embodiment pixel for a rear projection display. The frame 12 is preferably a geometric frame that permits a pixel 10 to be inserted into a corresponding receptacle in one unique or multiple distinct positions. In FIGS. 2A-2B, the geometric frame 12 includes angled sides 22 that preferably form a hexagon shaped bullet. A distorted asymmetrical variation of a hexagon may be used. Such a non-symmetrical structure in one cell of a corresponding receptacle array affects an adjacent cell by 180 degrees. This implies the pixel should work in both orientations, and it does work due to the nature of polarization (both 0 and 180 degrees receives the same signal). An advantage of having a single design shape in a pixel array is that only one tool/mold is needed for manufacturing pixels. Alternatively, separate sides of the frame 12 may be used for power and ground, with the frame constructed so two sides are conductive, but insulated from each other.

One or more of the sides 22 may be conductive to provide power through the sides by contact with an appropriately configured receptacle array, and pins 24 extending from the rear side edges of the frame 12 may serve to complete a circuit to ground, for example. In other embodiments, the pins 24 or the frame 12 form the sole electrical connection to both power and ground. The pins 24 may extend past the frame to connect to power or ground, or may bend back upon insertion into a receptacle such that the pins make contact with sides of the receptacles. The pixel of FIGS. 2A and 2B may accordingly be active immediately upon being inserted into an appropriately configured receptacle array. No wiring, soldering, or other operation is necessary to complete electrical connection. In the FIGS. 2A and 2B embodiment, the data, e.g., polarized encoded emissions are received on one side and the LED 18 produces a display on the other side.

FIG. 2C shows an alternative embodiment of the pixel 10 where the emissions are received on the same side as a display is produced (front projection). The LED 18 and the emission sensor 16 (unseen) are held adjacent to each other by the frame 12. The polarization filter 14 is fitted over the emission sensor 16 only, ensuring the emissions from the LED 18 are not polarized or reduced by an unnecessary filter. As a polarized emission 20 encounters the front end of the pixel, filtering is conducted in a similar manner as described above. This embodiment allows for the invention to be utilized in front projection optically addressable display systems. Similar embodiments include multiple filters, sensors and LEDs on the same side to form a multi-color front projection pixel.

The polarization filter 14 can be a linear filter that is sensitive to its rotational position. Altering the rotational position of the pixel 10 then alters the response of the pixel. Particularly, different rotational positions make the pixel 10 responsive to different phases of polarized emissions. This feature is realized, for example, by the exemplary hexagonal shape of the housing 12 allows the pixel 10 to be disposed in six different positions. Each position changes the response of the filter 14. This rotational sensitivity can be an important manufacturing and servicing benefit, especially for large stadium style displays that use collections of single color pixels. In embodiments of the invention, the rotational position of a pixel determines its color response. For example, 2 of 6 rotational positions produce a green response, 2 produce a red response, and 2 produce a green response. Accordingly, a single type of pixel can be manufactured within a single filter and the pixel is capable of being one of a plurality of colors depending upon its insertion position. This type of embodiment can be important, for example, as a replacement pixel. It is capable, depending upon its inserted position, of acting as a replacement for any single color pixel.

In another embodiment, the color of a replacement pixel 10 may be relatively unimportant. Embodiments of the invention include replacement pixels of an arbitrary single color of a particular color scheme to be placed in any geometric location of a pixel array. Another embodiment places a rotationally sensitive filter 14 of a replacement pixel arbitrarily, such that it produces, for example, one of the red, green or blue responses. The response of such a replacement pixel replaces a “dead” pixel, which draws significant attention, with a responsive pixel that fills in dead space with an arbitrary color of the color scheme. The replacement pixel becomes virtually undetectable in a large display, even if it responds to a different color than the “dead” pixel it replaces.

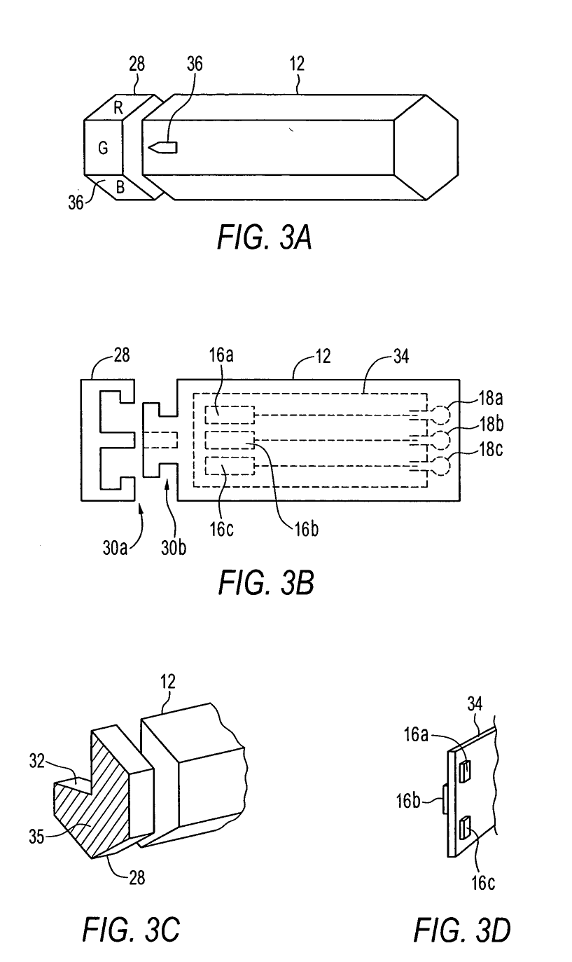

FIGS. 3A-3D illustrate an exemplary embodiment pixel that is rotationally sensitive, capable of producing any one of three colors depending upon its insertion configuration. A polarizer cap 28 attaches to the frame 12. The cap 28 is can be rotated with respect to the frame 12, for example, with snap-fit formations 30a and 30b. Depending upon this respective rotational position, a polarized window or gap filter 32 will pass emissions of a proper band to one of three sensors, 16a, 16b, 16c, formed or mounted on a printed circuit board 34 along with respective LEDs 18a, 18b, 18c. Blacked-out portions 35 prevent the activation of two out of the three sensors 16a, 16b, and 16c. The cap 28 and frame 12 may include indicia 36 to aid in selecting a color. The sensors may be on opposite sides of the printed circuit board 34, as seen in the partial end view of the PCB 34 in FIG. 3D.

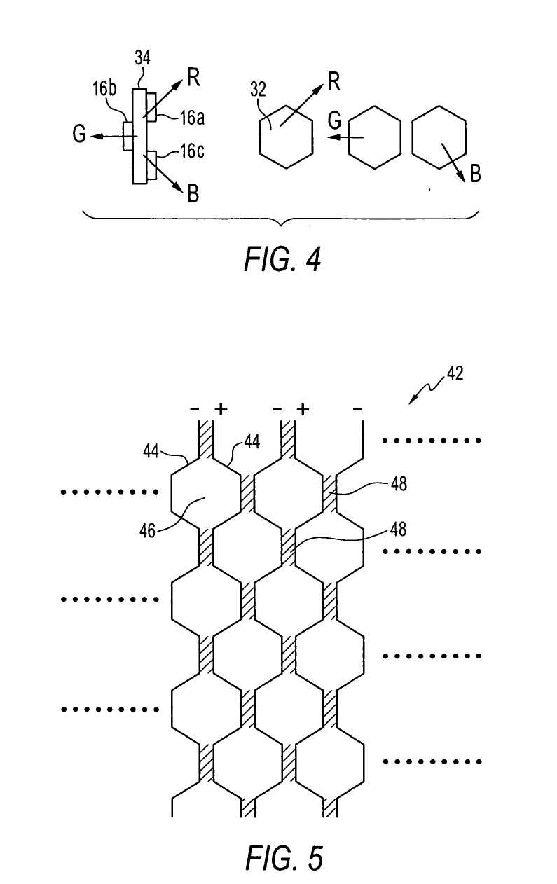

In another embodiment, the sensors 16a, 16b, 16c are themselves filtered, preferably responsive to polarization bands 1200 apart. As seen in FIG. 4, the rotational position of a polarizer window 32 (with no blacked-out portions) determines which of the sensors 16a, 16b, 16c and corresponding colors is active. Another possibility is to omit the cap 28 in favor of a plane filter, for example, that is placed over an entire array of pixels.

It should be noted that it may be desirable, in some instances, to group emission devices, e.g., LEDs, of different colors to the same band and filters. For example, some color management schemes provide colors by a mix of two emissions of different colors. In that case, for example, there could be additional bands for activating mixed groups of LEDs together, whether they are in a common frame or in a different frame. Thus, a display color may be formed by one color of emission device or emission devices, or multiple colors of emission devices.

A portion of preferred receptacle array 42 is shown in FIG. 5. Conductors 44 are shaped into a honeycomb. Each receptacle 46 accepts a pixel. Alternating rows of the conductors 44 may be positively and negatively charged to provide power to the frames 12 of inserted pixels. This permits pixels that omit the pins shown in FIGS. 2A-2C as electrical power is supplied exclusively through the frame. Insulating adhesive 48 is formed between alternating ones of the conductors 44 to prevent shorting and hold the structure together. The insulating adhesive 48 also adds capacitance to the array 42. This helps keep supplied power clean and free of noise. Use of another form of mechanical connection between conductors, or limited use of adhesive (such as at ends of conductors) permits other forms of insulation to be used between the conductors, e.g., air gaps.

The array 42 provides close packing of pixels and also provides structural integrity. A pixel does not need to be permanently fixed to the honeycomb structure, allowing the pixel to be a removable “plug-in” type pixel. The pixel 10 may be repositioned, replaced, or interchanged if needed. Because pixels are removable, repair time and costs are lowered. The entire honeycomb array 42 comprised of pixels does not have to be replaced if a pixel becomes damaged or stops working; only the damaged pixel needs to be removed. On-site customer repair is also made possible because no wiring is necessary to replace a pixel. The array 42 provides power to a plugged in pixel upon insertion as has been previously described. In preferred embodiments, the only PCB is internal to the replaceable pixels, as seen in FIGS. 3A-3D. In addition to a pixel including display elements (LED 18), pixels that include only a capacitor may be inserted into receptacles 46. The addition of a capacitor will also help keep the power bus formed through the honeycomb by the conductors 44 clean and free from noise. Plural receptacle arrays may also be connected together to form larger optically addressed displays. Lower resolution displays can be realized by skipping cells. These skipped cells can also be used by the capacitor cells. Additionally, larger displays can be realized by dedicating each cell to one color pixel where multiple pixels can be used to realize colors at a distance.

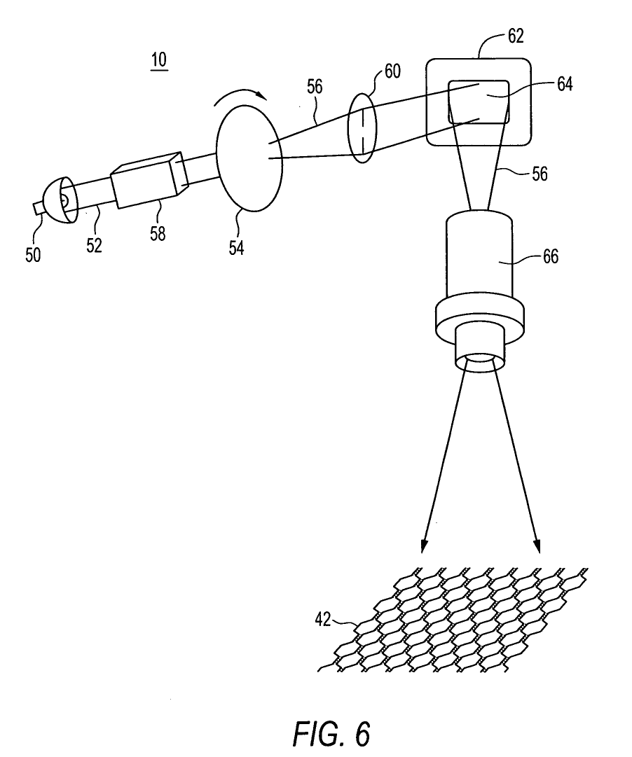

Referring now to FIG. 6, a method of delivering color information to an optically addressable display will be described with respect to a preferred embodiment display. An infrared source 50 generates emissions 52 in the non-visible spectrum. In other embodiments, visible spectrum emissions or other non-visible spectrum emissions are used. The emissions 52 pass through a rotating polarization filter 54. As the filter 44 rotates, the emissions 52 will pass through multiple polarization bands that can be assigned to particular color channels producing polarization emissions 56. As an example, the polarized emissions 56 can be assigned with respect to bands near the peaks of 0 degrees, 120 degrees, and 240 degrees for the color data channels for red, green, and blue, respectively. These channels may also be respectively assigned bands around the corresponding peaks that are 180 degrees out of phase, namely peaks at 180 degrees, 300 degrees, and 60 degrees. The polarized emissions 56 intensities are made uniform by an integrating rod 58, which might be placed prior to the filter 54 to avoid an altering of the polarization. A condensing lens 60 may be used to ensure coverage of a data encoder, such as a digital micro mirror device (DMD) 62, e.g., a DMD manufactured by Texas Instruments. The polarized emissions 56 encompass an array 64 of individually controlled mirrors DMD 62. Data is applied to the DMD 62, timed with the color channels determined by the rotating filter 54 so that data may be applied to different color channels, e.g., red, green and blue. During a red color channel, the DMD 62 activates only those mirrors having red data during that cycle, for example. A projection lens 66 focuses emissions directed by the DMD 62 toward emission sensors in a pixel array 42.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An optically addressable pixel, comprising:
a emission sensor;
a filter disposed to filter emissions directed toward said emission sensor;
a emission device responsive to said emission sensor;
a frame configured to hold said emission sensor, said emission device and said filter, and to pass electric current to said emission device when an outer surface of said frame is brought into contact with a powered conductor.

2. The pixel according to claim 1, wherein said filter emission sensor receives emissions on one side of the pixel and said emission device produces a display on the one side.

3. The pixel according to claim 2, wherein said emission sensor is held adjacent to said emission device by said frame on the one side.

4. The pixel according to claim 1, said filter receives emissions on one side of said pixel and said emission device produces a display on an opposite side of said pixel.

5. The pixel according to claim 1, comprising a plurality of respective emission sensors, filters and emission devices held in said frame.

6. The pixel according to claim 5, wherein said each of said plurality of filters comprises a polarization filter, and each of said plurality of respective emission sensors is responsive to a different band of polarization phases.

7. The pixel according to claim 6, further comprising a printed circuit board held in said frame, said printed circuit board electrically connecting said plurality of emission devices and said plurality of respective emission sensors.

8. The pixel according to claim 1, wherein said filter comprises a polarization filter, the pixel further comprising:
a rotatable cap connected to said frame, said polarization filter being held by said cap); and
a plurality of respective emission sensors and emission devices held in said frame;
wherein a rotational position of said cap determines which one or more of said plurality of respective emission sensors may receive emissions of a proper band to activate emission devices of a respective single color.

9. The pixel according to claim 8, further comprising blacked out portions on said polarization filter to align with all emissions sensors corresponding to all but one or more of said plurality of emission sensors based upon the rotational position of said cap.

10. The pixel according to claim 8, wherein said plurality of respective emission sensors are polarization sensitive, with at least one emission sensor in said plurality of emission sensors corresponding to each of a plurality of colors of emission devices in said plurality of emission devices, and wherein emission sensors corresponding to different colors are responsive to different polarization bands, and wherein the rotational position of said cap determines which of said colors are active.

11. A receptacle array, comprising
a pixel of claim 1, inserted into a receptacle array, the receptacle array including a plurality of receptacles shaped to accommodate pixels, each of said receptacles making electrical contact with the frame of an inserted pixel

12. The receptacle array of claim 11, wherein said frame and said receptacles are hexagon shaped.

13. The receptacle array of claim 11, wherein said plurality of receptacles are shaped to configure said receptacle array in a honeycomb shape.

14. The receptacle array of claim 11, wherein said receptacles are formed from rows of conductors, with insulation disposed between alternating ones of the conductors.

15. An optically addressed display device, comprising
a receptacle array of claim 11, wherein said pixel is one of many pixels in said receptacle array, and each said pixel includes at least three LEDs of different colors as emission devices, and said pixels are part of an optically addressed display device including:
an emission source and optics defining multiple color channels with emissions of multiple polarization states;
said filter comprising filtering to make commonly colored LEDs responsive to different emissions than other sets of commonly colored LEDs; and
a data encoder that applies data, on a pixel-by-pixel and channel-by-channel basis to said emissions by permitting emissions to reach a pixel indicated to be on by the data.

16. The display device of claim 15, wherein said LEDs are powered through an electrical contact between said receptacles and respective frames of said pixels.

17. The display device of claim 16, wherein said filter comprises a set of color filters to make commonly colored LEDs responsive to different emissions than other sets of commonly colored LEDs.

18. The display device of claim 15, said receptacles are formed from rows of conductors, with insulation disposed between alternating ones of the conductors.

19. A pixel for an optically addressed display, comprising:
a frame shaped to fit into a corresponding receptacle;
emission devices of plural colors held within the frame to make electrical contact with a power circuit when the frame is inserted into a corresponding receptacle; and
for each of the plural colors, an emission sensor that responds to emissions by activating an emission device or emission devices of one or more of the plural colors

20. The pixel of claim 19, further comprising, for each emission sensor corresponding to one or more of the plural colors, a filter that passes a band of emissions different from that of emission sensors corresponding to others of the plural colors.

21. The pixel of claim 20, wherein each of said filters comprises a polarization filter, each being physically identical but rotationally positioned to be pass a band of polarized emissions different from that of filters corresponding to others of the plural colors.

22. The pixel of claim 19, wherein said emission devices comprise LEDs positioned to produce a display on one side of the frame and said filters and emission sensors are positioned to receive emissions from an opposite side of the frame.

23. The pixel of claim 19, wherein said emission devices comprise LEDs positioned to produce a display on one side of the frame and said filters and emission sensors are positioned to receive emissions from said one side of the frame.

24. The pixel of claim 19, comprising one emission device of each of the plural colors.

25. The pixel of claim 19, comprising a plurality of emission devices of each of the plural colors.

26. The pixel of claim 19, wherein said emission devices make electrical contact through pins that extend from the frame.

27. The pixel of claim 19, wherein said emission devices make electrical contact through their respective frames.

28. A method of producing display from a pixel in an optically addressed pixel array, the method comprising the steps of:
selectively positioning an optically addressed pixel capable of displaying multiple colors to receive a specific phase of a polarized emission and accordingly display only one of the multiple colors;
inserting said pixel into a receptacle array in the position determined in said step of selectively positioning; and
supplying power to said pixel.

29. The method of claim 28, wherein the step of supplying power supplies power through the receptacle array.

30. The method of claim 28, carried out to replace a pixel in the optically addressed pixel array.

31. A pixel for an optically addressed display, comprising:
means for producing displays of a plurality of colors;
sensor means for each of the plurality of colors to activate said means for producing in response to received emissions; and
means for making each of said sensor means responsive to emissions of a different polarization band.

32. An optically addressable pixel, comprising:
a emission sensor;
a emission device responsive to said emission sensor;
a frame configured to hold said emission sensor and said emission device, and to pass electric current to said emission device when an outer surface of said frame is brought into contact with a powered conductor.

33. The pixel according to claim 32, further comprising a printed circuit board held in said frame, said printed circuit board electrically connecting said emission device and said emission sensor.

34. The pixel according to claim 32, wherein said emission device is of an arbitrary color of a color scheme and serves to replace a pixel of said arbitrary color or another color of said color scheme.

35. A receptacle array, comprising:
a pixel of claim 32, inserted into a receptacle array, the receptacle array including a plurality of receptacles shaped to accommodate pixels, each of said receptacles making electrical contact with the frame of an inserted pixel

36. The receptacle array of claim 35, wherein said frame and said receptacles are hexagon shaped.

37. The receptacle array of claim 35, wherein said plurality of receptacles are shaped to configure said receptacle array in a honeycomb shape.

38. The receptacle array of claim 35, wherein said receptacles are formed from rows of conductors, with insulation disposed between alternating ones of the conductors.

39. The receptacle array of claim 38, further comprising at least one capacitive element inserted into at least one of said plurality of receptacles.

40. A receptacle array, comprising:
rows of conductors shaped to define pixel receptacles between the conductors;
insulation between the rows of the conductors to isolate; wherein the rows of the conductors and insulation are arranged to provide power and ground through alternating ones of said rows of conductors.

41. The receptacle array of claim 40, wherein said rows of conductors are shaped into a honeycomb shape that defines hexagonal pixel receptacles.

42. The receptacle array of claim 40, wherein said insulation comprises insulating adhesive that joins said rows of conductors.
